(19) United States
(12) Patent Application Publication
(10) Pub. No.: US 2026/0322684 A1
(43) Pub. Date: Oct. 15, 2026

(54) TRANSACTIONAL OUT-OF-BAND DATA HANDLING

(71) Applicant: Cisco Technology, Inc., San Jose, CA (US)

(72) Inventors: Viktoria Fordos, Varmdo (SE); Claes Daniel Nasten, Burea (SE); Erik Torbjorn Ryeng, Stockholm (SE)

(21) Appl. No.: 19/243,190

(22) Filed: Jun. 19, 2025

Related U.S. Application Data
(60) Provisional application No. 63/785,912, filed on Apr. 9, 2025.

(51) Int. Cl. H04L 41/0803; H04L 41/04; H04L 41/0859

(52) U.S. Cl. CPC H04L 41/0803; H04L 41/04; H04L 41/0859

(57) ABSTRACT

Transactional handling of out-of-band (OOB) service requests that are performed in an atomic, consistent, isolated, and durable manner. The techniques may utilize a new transaction type to enable an orchestrator of a network to perform transactional OOB handling of service requests and implement partial keep operations of OOB changes made by devices. By utilizing the new transaction type, an orchestrator may prevent configuration changes based on stale data from being pushed to the network and prevent spoiling of the data store of the orchestrator, thereby reducing device errors and outages within a network.

### CROSS REFERENCE TO RELATED APPLICATIONS

This application claims priority to U.S. Provisional Patent Application No. 63/785,912, filed Apr. 9, 2025, the entire contents of which are incorporated herein by reference.

### TECHNICAL FIELD

The present disclosure relates generally to computer networking, and more particularly to orchestrator handling of out-of-band (OOB) requests in a network.

### BACKGROUND

Brownfield environments may refer to scenarios where a network controller is out of sync with one or more devices. For instance, in large-scale networks, out-of-band (OOB) changes occur often. For instance, there may be more than one entity (e.g., such as network users, scripts, multiple network controllers, etc.) making changes to the same set of devices. As an example, service provider networks may be operated with many tools and users accessing network elements and making changes directly out of band from the network controller to realize different network functions (e.g. setting up a VPN). Accordingly, operating such large-scale networks pose unique challenges to network controllers that can result in stale data being used by the network controllers and/or a data store of the controller being spoiled.

### BRIEF DESCRIPTION OF THE DRAWINGS

The detailed description is set forth below with reference to the accompanying figures. In the figures, the left-most digit(s) of a reference number identifies the figure in which the reference number first appears. The use of the same reference numbers in different figures indicates similar or identical items. The systems depicted in the accompanying figures are not to scale and components within the figures may be depicted not to scale with each other.

FIG. 1 illustrates a system architecture for enabling an orchestrator to perform atomic, consistent, isolated, and durable (ACID) transactional handling of out-of-band (OOB) requests.

FIGS. 2A and 2B illustrate example environments that include configuration state(s) associated with a controller and a device, according to the techniques described herein.

FIG. 2C illustrates and example environment illustrating chaining associated with a new transaction type, according to the techniques described herein.

FIG. 3 illustrates a component diagram of an example orchestrator that can be utilized to implement aspects of technologies disclosed herein.

FIG. 4 illustrates a flow diagram for performing ACID OOB transaction handling, according to the techniques described herein.

FIG. 5 illustrates a flow diagram of an example method for performing a rollback operation, according to the techniques described herein.

FIG. 6 is a computer architecture diagram showing an illustrative computer hardware architecture for implementing a computing device that can be utilized to implement aspects of the various technologies presented herein.

### DESCRIPTION OF EXAMPLE EMBODIMENTS

### Overview

The present disclosure relates generally to computer networking, and more particularly to orchestrator handling of out-of-band (OOB) requests in a network.

The present disclosure describes a method for enabling an orchestrator to perform transactional handling of OOB service requests. The method may include determining, based on receiving an OOB service request associated with an OOB change, that a device and the orchestrator are out of sync, the OOB change causing the device to move from a first state to a second state; determining to perform a partial keep operation to accept a first portion of the OOB change and reject a second portion of the OOB change; generating a transaction object comprising a read-set that includes read operations of the OOB change and one or more write-sets that include the first portion of the OOB change and reject operations; and based on determining the transaction object does not include operations based on stale data: causing, based on the one or more write-sets, the orchestrator to move to a third state associated with the device; generating, based on the one or more write-sets, a change set that comprises commands to (1) reset a configuration of the device to a stored configuration associated with the first state and (2) apply the second portion of the OOB change to move the device to the third state; and pushing the change set to the device.

Additionally, the techniques described herein may be performed by a system and/or device having non-transitory computer-readable media storing computer-executable instructions that, when executed by one or more processors, performs the method described.

### Example Embodiments

Brownfield networks may refer to an environment where a network controller is out of sync with one or more devices. For instance, in large-scale networks, out-of-band (OOB) changes occur often. For instance, there may be more than one entity (e.g., such as network users, scripts, multiple network controllers, etc.) making changes to the same set of devices. As an example, service provider networks may be operated with many tools and users accessing network elements and making changes directly out of band from the network controller to realize different network functions (e.g. setting up a VPN). In another example, a controller may be unable to sync with another controller due to the other controller being associated with a large, non-transactional device (e.g., such as Meraki dashboard, AWS dashboard, etc.). Accordingly, operating such large-scale networks can pose unique challenges to network controllers.

While some network controllers provide rudimentary tools to reject or accept OOB data, existing techniques fail to prevent stale data from being stored or used by network controllers or fail to bring devices and network controllers fully in sync. For instance, under existing techniques, when an OOB transaction fails, the network controller and the device may be left in an even more diverged state. Further, existing techniques may lack consistency resulting in outdated revert requests being pushed to devices. Moreover, existing techniques may not perform handling of OOB requests in isolation. This may result in intermediate effects of OOB handling on the network controller may be seen by other transactions that in turn produce malformed requests towards the devices. Further, existing techniques may lack durability, resulting in the accepted OOB changes being invisible to the network controller. By failing to have visibility at the network controller, transactions between the network controller and a device may be malformed and/or use inaccurate assumptions, resulting in the device rejecting the changes, causing a service disruption, and/or bringing the device offline.

Accordingly, existing techniques may cause the data store of the network controller to be spoiled with unhandled OOB data (e.g., such as when OOB handling fails due to device errors) and network devices may receive stale updates from the network controller, which can result in a device error (e.g., such as the network device committing an incorrect configuration) and can result in service being lost throughout the network (e.g., such as where the device is a server, etc.).

The techniques described herein provide a new type of transaction that enables an orchestrator (e.g., a controller) of a network to perform transactional atomic consistent isolated and durable (ACID) OOB handling of OOB requests. The techniques may ensure that (1) the network controller's data store doesn't get spoiled with unhandled OOB data when OOB handling fails due to device errors; and (2) the network devices won't receive stale updates from the network controller. Thus, the techniques may prevent and/or reduce device errors and network outages from occurring due to stale or spoiled data.

The techniques may be implemented by an orchestrator of a network, and may include determining, based on receiving an OOB service request associated with an OOB change, that a device and the orchestrator are out of sync, the OOB change causing the device to move from a first state to a second state; determining to perform a partial keep operation to accept a first portion of the OOB change and reject a second portion of the OOB change; generating a transaction object comprising a read-set that includes read operations of the OOB change and one or more write-sets that include the first portion of the OOB change and reject operations; and based on determining the transaction object does not include operations based on stale data: causing, based on the one or more write-sets, the orchestrator to move to a third state associated with the device; generating, based on the one or more write-sets, a change set that comprises commands to (1) reset a configuration of the device to a stored configuration associated with the first state and (2) apply second portion of the OOB change to move the device to the third state; and pushing the change set to the device.

As used herein, an “orchestrator” of a network may correspond to a network services orchestrator configured to perform controller functionalities and orchestration functionalities. As used herein, a “network controller” and/or “controller” may correspond to one or more of the controller functionalities performed by the orchestrator and/or to a separate controller managed by the orchestrator. For instance, the “controller” functionalities may include, but are not limited to configuration management (e.g., management of network devices, managing configuration(s) of device(s) in a network), state management (e.g., monitoring and managing state(s) of network devices and services, automatically recovering or remediating issues when deviations from the desired state are detected), abstraction (e.g., abstracting away the complexities of managing different types of network devices; providing a unified interface to a user device to enable the user to interact with various devices and their configurations), and transaction management (e.g., complex configuration changes in a transaction-safe manner, ensuring that all changes are applied together, portions are applied, or none are applied at all). The “orchestrator” functionalities may include, but are not limited to inter-device coordination (e.g., coordinating the actions of multiple network devices to achieve a larger network objective, such as deploying a specific service or modifying a network topology), service lifecycle management (e.g., managing entire lifecycle of network services, from deployment to modification to deletion), cross-domain automation (e.g., automating services across different network domains, including physical, virtual, and cloud-based infrastructure), integration with other systems (e.g., integrating with other automation and orchestration frameworks, such as DevOps tools, OSS/BSS systems, and business process workflows), etc. As used herein a “service” is an abstraction that transforms a user intent into device configuration changes.

In some examples, the system may utilize a new type of transaction to enable the orchestrator to provide atomic, consistent, isolated, and durable (ACID) OOB handling of service intents. For instance, the new transaction type may be transactional and may be utilized where there are two or more diverged backends maintaining multiple write-sets. For instance, the new transaction type may be used by the orchestrator where a device is out of sync with the orchestrator (e.g., such as where there are other entities (e.g., other controllers, users, etc.) making configuration changes to the device; where there are multiple orchestrators managing the network and/or the device and both try to make configuration changes; and/or where the orchestrator is connected to a large non-transactional device (e.g., such as a device that the orchestrator may not be able to fully sync with (e.g., Meraki dashboard, AWS dashboard, etc.), such that the orchestrator operates the device via (1) connects, (2) partial syncs, and/or (3) commit(s) calls of change set(s)).

In some examples, the new transaction type may be configured to perform partial keeps of a configuration change made OOB at the device. The new transaction type may be configured to determine two different change sets (e.g., one change set for the controller and one change set for the device). For instance, as described herein, the change set for the controller may comprise configuration command(s) to incorporate the partial keep of the OOB configuration change and update the state of the controller to align with the device. The change set for the device may comprise configuration commands to reset the values of the device to an initial state (e.g., referred to as “State_0”) of the device that is stored by the orchestrator, applies the partial reject operations of the OOB configuration changes, and updates the state of the device to align with the controller.

In some examples, the orchestrator may utilize the new transaction type to perform rollback operation(s). For instance, the orchestrator may perform rollback operations where the orchestrator fails to push a change set to the network and/or where the orchestrator receives input (e.g., such as from a user device) to rollback configuration changes that are successfully made to the device and/or controller. For instance, where the configuration changes are successfully committed to bring the device and orchestrator back in sync, the user may provide input (e.g., a service intent) to revert the device and the controller to a prior, out-of-sync state and configuration. In this example, the orchestrator may utilize the new transaction type to determine a first change set for the controller that includes configuration commands to reset the controller to the configuration stored in the initial state. The new transaction type may also determine a second change set to move the device from the updated state to a previous configuration associated with an out-of-sync state (e.g., referred to herein as “State_1”). Accordingly, the new transaction type may be utilized by the orchestrator to determine the new configuration(s) and/or new state(s) of device(s) and controller(s). As described herein, by using the new transaction type and performing various checks, the orchestrator may prevent spoiling of the data store utilized by the controller and prevent change sets based on stale data from being pushed to network devices, thereby preventing device errors and associated network outages from occurring due to stale data.

Accordingly, the techniques described herein may be used to reduce device errors and prevent network outages by providing a new transaction type that can start from different states between the controller and the device; can maintain completely different change sets towards the controller and the device; and can move the controller and the device to states that are synchronized by applying the change sets. Further, the techniques may provide customization to an operator by enabling the operator and/or system to perform rollback operations using the new transaction type. Accordingly, the techniques may provide a new transaction type that can be applied towards two diverged backends maintaining multiple write-sets, resulting in an orchestration system that has improved consistency, durability, and accuracy of OOB handling. Further, the techniques may improve the functioning of the orchestrator. For instance, by reducing the use of stale data, the techniques may reduce computational costs and improve the functioning of the orchestrator by minimizing configurations pushed to devices and/or rollback operations that need to be performed due to device errors.

Certain implementations and embodiments of the disclosure will now be described more fully below with reference to the accompanying figures, in which various aspects are shown. However, the various aspects may be implemented in many different forms and should not be construed as limited to the implementations set forth herein. The disclosure encompasses variations of the embodiments, as described herein. Like numbers refer to like elements throughout.

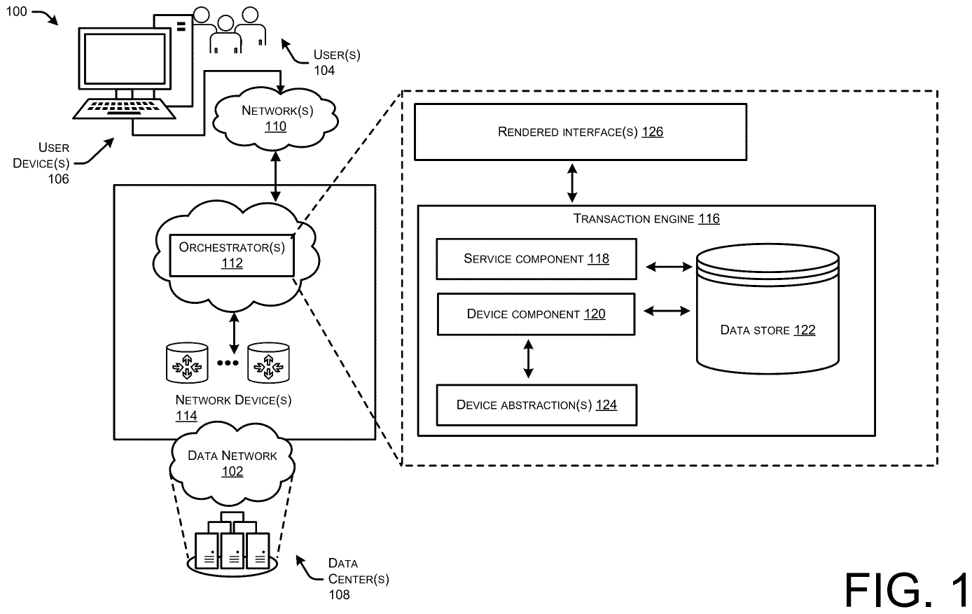

FIG. 1 illustrates a system 100 for enabling an orchestrator to perform atomic, consistent, isolated, and durable (ACID) transactional handling of out-of-band (OOB) requests. The system 100 includes a data network 102, and in which user(s) 104 of user devices 106 utilize a domain-specific language to express and compile network functions to perform network operations. FIG. 1 further illustrates an orchestrator 112 (also referred to as a controller herein) in the data network 102 configured to perform out-of-band (OOB) handling of OOB transaction requests received from network device(s) 114 and/or service(s) in the data network 102. In some examples, the orchestrator(s) 112 may be implemented as part of a service (e.g., such as Network Services Orchestrator) provided by a service provider (e.g., such as Cisco) of the data network(s) 102.

In some examples, the data network 102 may include devices housed or located in one or more data centers 108. The data network 102 may include one or more networks implemented by any viable communication technology, such as wired and/or wireless modalities and/or technologies. The data network 102 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)—both centralized and/or distributed—and/or any combination, permutation, and/or aggregation thereof. The data network 102 may include devices, virtual resources, or other nodes that relay packets from one network segment to another by nodes in the computer network. The data network 102 may include multiple devices that utilize the network layer (and/or session layer, transport layer, etc.) in the OSI model for packet forwarding, and/or other layers. The data network 102 may include various hardware devices, such as routers, switches, gateways, smart NICs, NICs, ASICs, FPGAs, servers, and/or any other type of device. Further, the data network 102 may include virtual resources, such as VMs, containers, and/or other virtual resources.

The one or more data centers 108 may be physical facilities or buildings located across geographic areas that are designated to store networked devices that are part of the data network 102. The data centers 108 may include various networking devices, as well as redundant or backup components and infrastructure for power supply, data communications connections, environmental controls, and various security devices. In some examples, the data centers 108 may include one or more virtual data centers which are a pool or collection of cloud infrastructure resources specifically designed for enterprise needs, and/or for cloud-based service provider needs. Generally, the data centers 108 (physical and/or virtual) may provide basic resources such as processor (CPU), memory (RAM), storage (disk), and networking (bandwidth). However, in some examples, the devices in the data networks 102 may not be located in explicitly defined data centers, but may be located in other locations or buildings.

The user devices 106 may establish communication connections over one or more network(s) 110 to communicate with device(s) (e.g., such as network device(s) 114, orchestrator(s) 112, etc.) or other device(s) or services in the data network 102. The network(s) 110 may include any viable communication technology, such as wired and/or wireless modalities and/or technologies. Network(s) 110 may include any combination of Personal Area Networks (PANs), Local Area Networks (LANs), Campus Area Networks (CANs), Metropolitan Area Networks (MANs), extranets, intranets, the Internet, short-range wireless communication networks (e.g., ZigBee, Bluetooth, etc.) Wide Area Networks (WANs)-both centralized and/or distributed—and/or any combination, permutation, and/or aggregation thereof. The user devices 106 may communicate using any type of protocol over the network(s) 110, such as the transmission control protocol/Internet protocol (TCP/IP) that is used to govern connects to and over the Internet.

As illustrated, the orchestrator(s) 112, may include transaction engine 116, service component 118, device component 120, data store 122, device abstraction(s) 124, rendered interface(s) 126. The orchestrator(s) 112 may include additional, alternative, or fewer components and are not limited to the components illustrated herein.

In some examples, the orchestrator(s) 112 are configured to perform controller functionalities and orchestration functionalities. For instance, the orchestrator(s) 112 may be configured to perform one or more of configuration management (e.g., management of network devices, managing configuration(s) of device(s) in a network), state management (e.g., monitoring and managing state(s) of network devices and services, automatically recovering or remediating issues when deviations from the desired state are detected), abstraction (e.g., abstracting away the complexities of managing different types of network devices; providing a unified interface to a user device to enable the user to interact with various devices and their configurations), transaction management (e.g., complex configuration changes in a transaction-safe manner, ensuring that all changes are applied together, portions are applied, or none are applied at all), inter-device coordination (e.g., coordinating the actions of multiple network devices to achieve a larger network objective, such as deploying a specific service or modifying a network topology), service lifecycle management (e.g., managing entire lifecycle of network services, from deployment to modification to deletion), cross-domain automation (e.g., automating services across different network domains, including physical, virtual, and cloud-based infrastructure), integration with other systems (e.g., integrating with other automation and orchestration frameworks, such as DevOps tools, OSS/BSS systems, and business process workflows), etc. In some examples, one or more of the above functionalities (controller functionalities and/or orchestration functionalities) may be performed by the service component 118 and/or the device component 120. For instance, the service component 118 may perform one or more of the functionalities associated with services of the data network 102. The device component 120 may be configured to perform one or more of the functionalities associated with device(s) of the data network 102.

Transaction engine 116 may be configured as a flexible and powerful built-in engine, which may simplify how user(s) 104 can apply configuration changes across network device(s) 114 of different types and provide additional validation against a target data model (e.g., configuration). In some examples, the transaction engine may utilize XML templates or any process instructions that may be used to map input to output programmatically. For instance, the transaction engine 116 may be configured to receive a service intent associated with a one or more network device(s) 114 (e.g., such as a single network device and/or a set of network device(s)) and may perform a process flow to determine whether to commit, abort, and/or retry the transaction.

Service component 118 may be configured to communicate with data store 122. For instance, the service component 118 may be configured to receive a service intent from the network (e.g., such as via rendered interface(s) 126). For instance, the service component 118 may receive a service intent (e.g., such as an OOB change request) via a Northbound Application Programming Interface (API). The service component 118 may be configured to send service write-sets to the data store 122 and/or receive service read-sets from the data store 122 that are associated with service model(s) and/or device model(s). The device component 120 may be configured to determine and deliver configuration changes to network device(s) 114. For instance, the device component 120 may calculate a southbound diff (e.g., a minimal set of operations (e.g., create, modify, delete, etc.) on the configuration level to deliver the change set to the network device). The device component 120 may utilize a Southbound API to deliver changes to the network device(s) 114, such as via device abstraction(s) 124 (e.g., representations of the network device(s) 114), and/or any other suitable component.

Data store 122 may be configured to store state(s) and model(s) associated with the network controller and network device(s) 114. For instance, the data store 122 may store service model(s) associated with service intent(s), device model(s) associated with state(s) and configuration(s) of device(s) in the data network 102, and/or any other suitable type of model. In some examples, the model(s) may comprise Yet Another Next Generation (YANG) models. YANG is a data modelling language for the definition of data sent over network management protocols such as the NETCONF, RESTCONF, CLI, SNMP, etc. YANG was first defined in RFC 6020 and can be used to model both configuration data as well as state data of network elements. YANG is a modular language representing data structures in an XML tree format. While examples described herein refer to YANG models, it is understood that the techniques described herein may utilize any modelling language in addition to, or as an alternative to YANG.

In some examples, the orchestrator 112 may receive a service request (also referred to as a service intent herein). The service request may arrive through the rendered interface(s) 126, such as via a northbound API of the orchestrator 112 and to the transaction engine 116. The rendered interface(s) 126 may include one or more application(s) associated with the network device(s) 114 and/or user device(s) 106. The service request may correspond to a service intent for an OOB change made to a configuration of a network device 114 made by a user 104 via network(s) 110. For instance, the service intent may comprise a read-set and/or a write-set of the configuration changes. The orchestrator(s) 112 may be configured to determine that a state of the network device 114 indicated by the OOB change is out of sync with a state of the network device stored in the data store 122 of the orchestrator(s) 112. The orchestrator(s) 112 may determine to perform a partial keep of the OOB change (e.g., keep a portion of the configuration changes made to the device and reject the remaining changes). For instance, the determination may be based on input received from user device(s) 106.

As described herein, the orchestrator 112 may utilize a new transaction type to perform ACID OOB handling of the service intent. For instance, the orchestrator(s) 112 may initiate a read transaction that loads the changes made to the initial state of the device by the OOB request into memory of a transaction associated with the service intent, where the changes are included as part of the change set of the transaction. The transaction may be linked to the data store 122, such that anything that is not included in the read/write-set of the transaction may be read from the initial state of the device stored in the data store 122. The orchestrator may initiate a second transaction (described in greater detail herein) that includes a read/write-set comprising reject operations representing a minimal set of changes to move the device between states (e.g., from an out-of-sync state to an in-sync state or vice versa). The second transaction may be chained to the transaction, such that the second transaction may read from the read/write-set of the transaction if something is not included in the read/write-set of the second transaction. Where the read/write-set of the transaction also does not include the information, the second transaction may subsequently read from the initial state stored in the data store 122. Once the second transaction determines the reject operations, the write-set of the second transaction may be stored in memory of the controller and then loaded into memory of the transaction. Subsequently, the second transaction may be closed. Accordingly, the orchestrator may utilize the second transaction and chaining to determine reject operations for performing a partial keep of an OOB request and/or a rollback of configuration changes. Thus, the transaction may comprise two write-sets. A first write-set may comprise the first portion of the OOB changes to apply to the orchestrator. The second write-set may comprise the reject operations.

At this point, the transaction may enter a critical section of the transaction engine and may take a lock. By taking the lock, the transaction engine ensures that only one transaction may be in the critical section at any given time. The transaction may leave the critical section (e.g., the critical section may end) when one of the following occurs: (i) the changes of the transaction are propagated to the network, or (ii) the transaction aborts. For instance, the transaction object may perform conflict detection inside the lock. If the conflict detection determines that the transaction does not conflict with any other transaction objects that have been committed since the transaction was generated, the transaction may be validated. If the incremental conflict detection finds conflict, the transaction may be aborted to prevent stale data from being sent to network device(s) 114. For instance, a conflict may be detected due to a subsequent transaction object being committed that changes a value used by the orchestrator when determining the change sets. With the value changed, the change set included in the transaction object is based on stale data, so propagating the change set to the network device(s) 114 may cause device errors and/or storing the data in the data store 122 may spoil the data store 122.

Where no conflict is detected, the orchestrator may save the first write-set of the transaction in persistent storage of the orchestrator. By saving the first write-set in persistent storage, the orchestrator causes the state of the controller to be updated. The orchestrator may then generate the change set for the device using the second write-set. The change set may comprise a minimal difference between the write-set of the second transaction and the write-set of the transaction. The orchestrator may then persist and propagate (e.g., deliver) the changes to the device in the data network using the southbound API. In some examples, the changes are propagated while still inside the critical section. The transaction object may then leave the critical section, and release all other acquired locks. The critical section of a lock carefully controls the incoming transactions, and prevents the transactions to access the lock at the same time. The transaction object may then terminate.

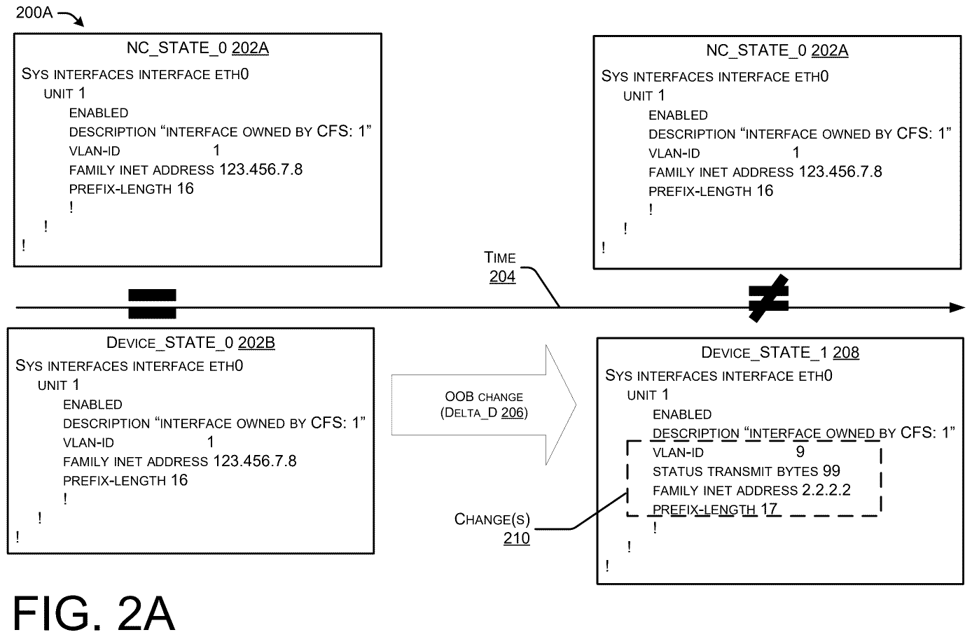

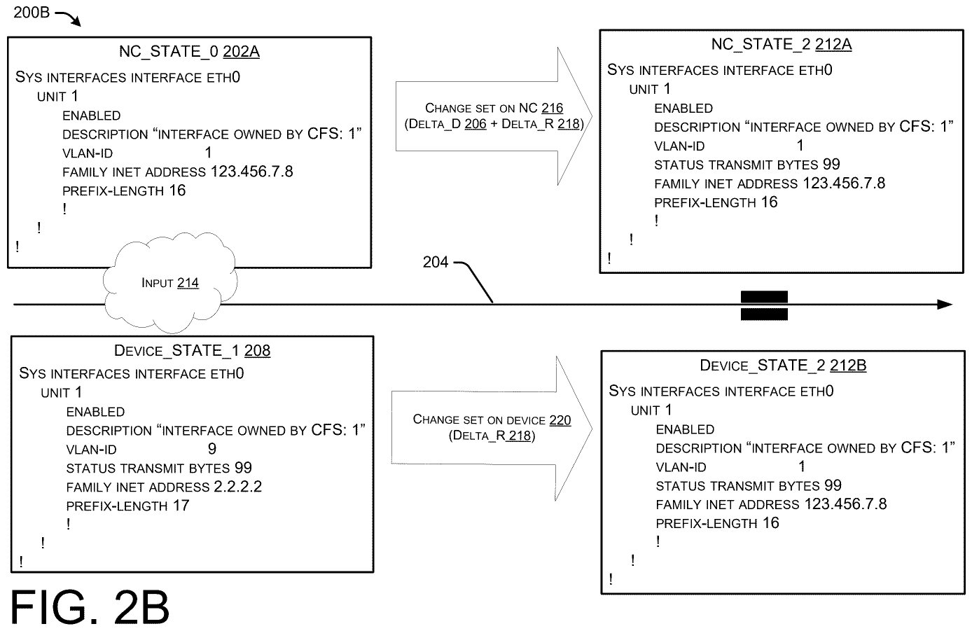

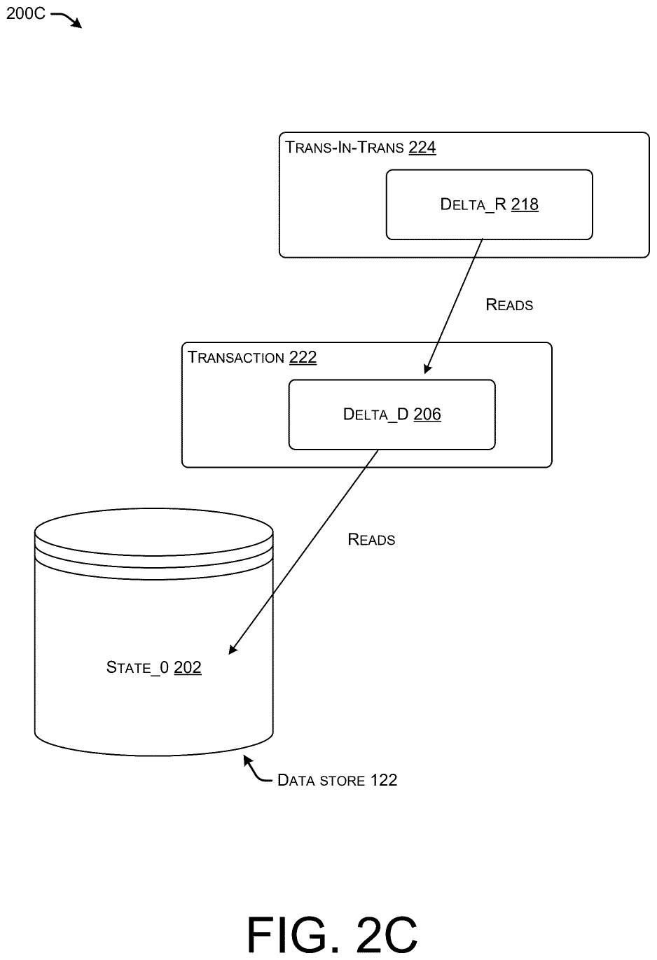

FIGS. 2A and 2B illustrate example environments that include configuration state(s) associated with a controller and a device, according to the techniques described herein. FIG. 2C illustrates an example environment illustrating chaining of the new transaction type, according to the techniques described herein. FIG. 2A may correspond to an example where a controller and a device move from being in sync to being out of sync. FIG. 2B may correspond to an example of how the new transaction type may cause the controller and the device to move back in-sync. For instance, FIG. 2B may show how the new transaction type moves the diverged backend to be back in-sync with the controller.

As illustrated in FIG. 2A, the example environment 200A may include NC_STATE_0 202A and Device_STATE_0 202B. NC_STATE_0 202A may correspond to a configuration representing an initial state and/or preferred state (e.g., State_0) of the network device that is stored by the controller and/or orchestrator 112. Device_STATE_0 202B may correspond to an initial configuration state of a device (e.g., such as a network device 114) within data network 102. As illustrated in FIG. 2A, the state(s) of the controller and the device may initially be synchronized (represented by the “=” sign on the left-hand side of FIG. 2A). However, as time 204 elapses, an event may cause the controller and the device to become out of sync. In the illustrated example, the event may correspond to an OOB change occurring at the device. For instance, the OOB change may comprise a configuration change and the orchestrator 112 may determine Delta_D 206 based on the OOB change. Delta_D 206 may represent the minimal difference (e.g., configuration commands) to move the configuration of the device stored in the data store 122 of the orchestrator 112 from State_0 to State_1. In the example illustrated in FIG. 2A, Delta_D 206 may comprise a change set that includes commands, such as:

```
sys interfaces interface eth0
  unit 1
    vlan-id 9
    status transmit bytes 99
    no family inet address 123.456.7.8
    family inet address 2.2.2.2
    prefix-length 17
    !
  !
!
```

Device_STATE_1 208 may represent the configuration of the network device after Delta_D 206 has been applied and/or committed by the device. As illustrated, committing the OOB changes at the device results in the device moving from State_0 to State_1. Specifically, the OOB changes have caused changes 210 in the configuration of the device from the configuration associated with State_0 that is stored by the controller. For instance, the commands included in Delta_D 206 have changed the configuration of State_0 by changing the values of “vlan-id”, “family inet address”, and prefix-length”, and added “status transmit bytes.” Thus, the device may be out of sync with the controller (represented by the “≠” sign on the right-hand side of FIG. 2A).

In FIG. 2B, the orchestrator 112 may receive input 214. For instance, the input 214 may comprise a service intent to perform a partial keep of the OOB changes. In the illustrated example environment 200B of FIG. 2B, the input 214 may correspond to instructions to “keep ‘bytes’ and reject everything else.” In this example, the orchestrator 112 may utilize the new transaction type to perform a partial keep operation to keep the “status transmit bytes 99” command included in Delta_D 206 and reject the remaining changes.

For instance, as described herein, the new transaction type may determine a first change set for the network controller (denoted as “change set on NC 216) to move the state of the device stored on the controller from NC_STATE_0 202A to NC_STATE_2 212A. For instance, for the controller, the transaction may determine to run a configuration command that sets the “bytes” according to Delta_D 206 and updates the state of the controller to State_2. The change set on NC 216 may be represented as:

State_0+Delta_D+Delta_R=State_2

Delta_R 218 may represent the reject operations from the OOB changes. Thus, by applying Delta_R 218 on top of Delta_D 206, the reject operations cancel out the changes made by Delta_D, such that the configuration commands become a null difference between Delta_D 206+Delta_R 218. As an example, the change set on NC 216 after Delta_R 218 is applied on top of Delta_D 206, may include the following commands:

```
sys interfaces interface eth0
  unit 1
    status transmit bytes 99
    !
  !
!
```

Thus, by applying the reject operations of Delta_R 218 to Delta_D 206, the rejected OOB change configuration instructions (e.g., vlan-id 9, no family inet address 123.456.7.8, family inet address 2.2.2.2, prefix-length 17) become null. As illustrated, NC_STATE_2 212A comprises the configuration of State_0 with the “status transmit bytes 99” instruction added to the configuration and the state updated.

The new transaction type may determine a second, different change set for the device (denoted as “change set on device 220”) to move the state of the device from Device_STATE_1 208 to Device_STATE_2 212B. For instance, to move the device from State_1 to State_2, the new transaction type may generate a change set comprising configuration commands that reset all the values of the device to Device_STATE_0 values (e.g., based on the NC_STATE_0 202A values of the device that is stored by the controller), while keeping the “bytes” value, resulting in the device being in state 2. To do this, the transaction type may determine the change set based on the following:

State_1+Delta_R=State_2

Thus, the transaction may determine a configuration command that deletes the stored address, adds the address from state_0, resets the vlan-id, and resets the prefix length. For instance, the new transaction type may apply Delta_R 218 (e.g., the reject operations) to Device_STATE_1 208 to move the device from state_1 to Device_STATE_2 212B. In this example, Delta_R 218 (e.g., the change set on device 220) may comprise configuration commands as follows:

```
sys interfaces interface eth0
  unit 1
    vlan-id 1
    no family inet address 2.2.2.2
    family inet address 123.456.7.8
    prefix-length 16
    !
  !
!
```

As noted above, the new transaction type may enable atomic OOB handling. Accordingly, in order for the orchestrator to use the new transaction type and provide atomicity, in the case of any failure of the change-set delivery, the orchestrator may perform a rollback operation such that the configurations of the device and controller are rolled back to where they were before the transaction started. In the above-described example, the rollback operations may comprise moving the controller from State_2 to State_0 and moving the device from State_2 to State_1. The orchestrator may utilize the new transaction type to determine the change sets for the controller and the device. For instance, the change set for the controller may be represented as follows:

State_2+reverse(Delta_d+Delta_R)=State_0

Where “reverse(Delta_D+Delta_R)” represents the calculation of NC_STATE_0 202A of the device. Further, the change set for the device may be represented as follows:

State_2+reverse(Delta_D+Delta_R)+Delta_D)=State_1

Where State_0 of the device is initially calculated (e.g., “reverse(Delta_D+Delta_R)”) and the original OOB change (e.g., Delta_D) is then applied to generate the change set of the device.

FIG. 2C illustrates an example environment 200C illustrating chaining of the new transaction type, according to the techniques described herein. As illustrated, the example environment 200C includes data store 122, state_0 202, Delta_D 206, and Delta_R 218. As described herein, the data store 122 may be configured to store state(s) of device(s) and/or service(s) as model(s). State_0 202 may refer to a configuration of the device corresponding to a preferred state of the device, such as a state indicated and/or configured by a user. In some examples, State_0 may represent a state of the device prior to being out of sync with the controller.

Example environment 200C further includes transaction 222. Transaction 222 may represent the transaction initiated by the orchestrator to perform the partial keep of the OOB changes. For instance, the orchestrator(s) 112 may initiate a read transaction that loads Delta_D 206 into memory of the transaction 222. As illustrated, the transaction 222 may be linked to the data store 122, such that anything that is not included in the read/write-set of Delta_D 206 may be read from State_0 202 stored in the data store 122.

The trans-in-trans 224 may represent a second transaction that is initiated by the orchestrator. The trans-in-trans 224 may determine and store a read/write-set comprising Delta_R 218 (e.g., the reject operations representing a minimal set of changes to move the device between states (e.g., from an out-of-sync state to an in-sync state or vice versa)). The trans-in-trans 224 may be chained to the transaction, such that the trans-in-trans 224 may read from Delta_D 206 if something is not included in Delta_R 218. If something is further not included in Delta_D 206, then the trans-in-trans 224 may read from State_0 202. Thus, the trans-in-trans 224 may use transaction 222 as a backend. The trans-in-trans 224 transaction may be configured to determine the reject operations. For instance, to generate the correct rejects, the trans-in-trans 224 may use a read transaction towards the controller that uses the read-set of the transaction 222. As illustrated, the write-set of the trans-in-trans is Delta_R 218. Accordingly, when the orchestrator saves Delta_R 218 in memory, the trans-in-trans 224 may be closed and the changes recorded in Delta_R 218 may be loaded to transaction 222. Thus, transaction 222 may comprise multiple write-sets, as described herein.

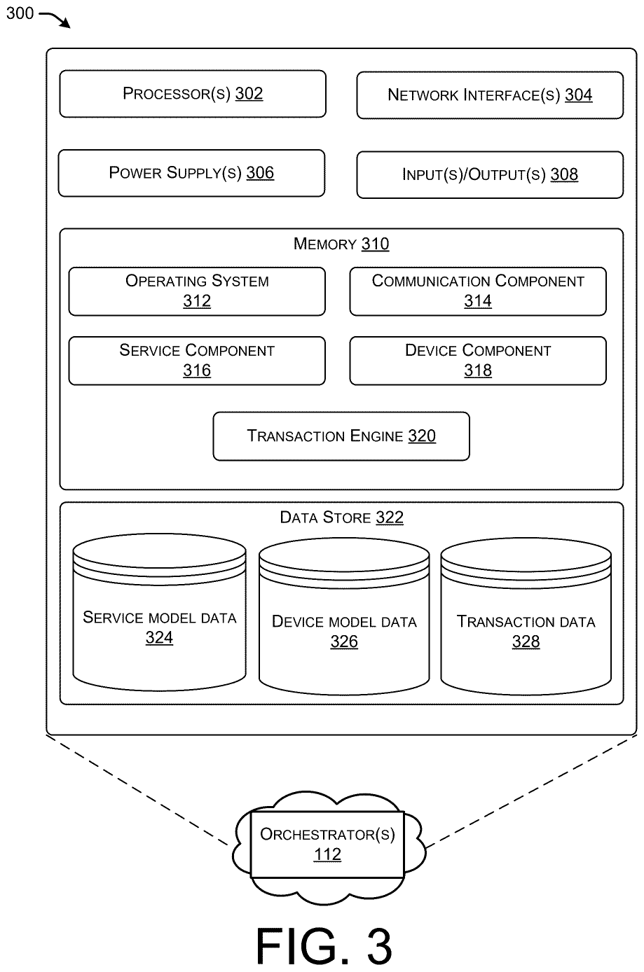

FIG. 3 illustrates a component diagram 300 of an example orchestrator (e.g., user device 106, network device 114, and/or orchestrator 112) configured to perform one or more functions, according to some aspects of the present disclosure. The orchestrator may be any type of computing device capable of receiving expressions of network functions via a network interface 304 and sending network commands to the network 110 via a suitable data communications network such as, but not limited to, a laptop or desktop computer, a tablet computing device, a server computer, a television, or a mobile telephone.

As illustrated, the orchestrator 112 may include one or more hardware processors 302 (processors), one or more devices, configured to execute one or more stored instructions. The processor(s) 302 may comprise one or more cores. Further, the orchestrator 112 may include one or more network interfaces 304 configured to provide communications between the orchestrator 112, and/or other systems or devices in the data network 102 and/or remote from the data network 102. The network interfaces 304 may include devices configured to couple to personal area networks (PANs), wired and wireless local area networks (LANs), wired and wireless wide area networks (WANs), and so forth. For example, the network interfaces 304 may include devices compatible with Ethernet, Wi-Fi, and so forth.

The orchestrator 112 can include one or more power supplies 306, such as one or more batteries, connections to mains power, etc. The orchestrator 112 can also include one or more inputs and outputs 308 for receiving and processing input from a number of input devices, such as a keyboard, a mouse, a touchpad, a touch screen, an electronic stylus, or other type of input device. Further, the input/outputs 308 can include a display, such as a computer monitor, a flat-panel display, a digital projector, a printer, or other type of output device. It will be appreciated that the orchestrator 112 might not include all of the components shown in FIG. 3, can include other components that are not explicitly shown in FIG. 3, or might utilize an architecture completely different than that shown in FIG. 3.

The orchestrator 112 may also include memory 310, such as computer-readable media, that stores various executable components (e.g., software-based components, firmware-based components, etc.). The memory 310 may generally store components to implement functionality described herein. The memory 310 may store an operating system 312 utilized to control the operation of components of the orchestrator 112. Further, the memory 310 may store a communication component 314 that comprises software (e.g., any protocol stack) to enable the orchestrator 112 to communicate with other devices using the network interface 304.

In some instances, the memory 310 may store a service component 316 configured to enable orchestrator 112 to read and/or write data (configuration data, service metadata, etc.) from/to transaction object associated with a service. The service component 316 may correspond to service component 118 of FIG. 1 and may perform operations as described herein. For instance, the service component 316 may comprises a human readable code or binary machine code, when executed on the processor 302, may enable the orchestrator 112 to read or write configuration data from/to a transaction object. In addition, the service component may enable the orchestrator 112 to commit the transaction object to memory, once the configuration data is read/written.

In some instances, the memory 310 may store a device component 318 (e.g., such as device component 120) configured to enable orchestrator 112 to perform one or more functionalities associated with device(s) in the data network 102. For instance, the device component 318 may be configured to determine and deliver configuration changes to network device(s) 114. For instance, the device component 318 may calculate a southbound diff (e.g., a minimal set of operations (e.g., create, modify, delete, etc.) on the configuration level to deliver the change set to the network device). The device component 318 may utilize a Southbound API to deliver changes to the network device(s) 114, such as via device abstraction(s) 124 (e.g., representations of the network device(s) 114), and/or any other suitable component.

In some instances, the memory 310 may store a transaction engine 320 (e.g., such as transaction engine 116) configured to determine the minimal set of operations on the configuration node level to deliver the result of a service intent. The transaction engine 320 may comprises a human-readable code or binary machine code, when executed on the processor 302, may enable the orchestrator 112 to calculate the effects of all collected transaction objects and/or determine the minimal set of operations on the configuration node level to deliver the result of a service invocation. In some examples, when a transaction object enters the critical section, the transaction engine 320 may be invoked.

The orchestrator 112 may further include a data store 322, which may comprise any type of computer memory including long-term memory (e.g., Read Only Memory (ROM), Random Access Memory (RAM), caches, etc.). The data store 322 may include service model data 324 that tracks all currently running network services and stores associated state(s) and configuration(s) of the service(s). Further, the data store 322 may include device model data 326 that tracks all currently running device(s) in the data network 102 and stores associated state(s) and configuration(s) of the device(s). 326 The data store 322 may include transaction data 328, which may comprise data and/or metadata associated with a transaction (e.g., such as the new transaction type, transaction 222, trans-in-trans 224, etc.) and/or a service intent within the data network.

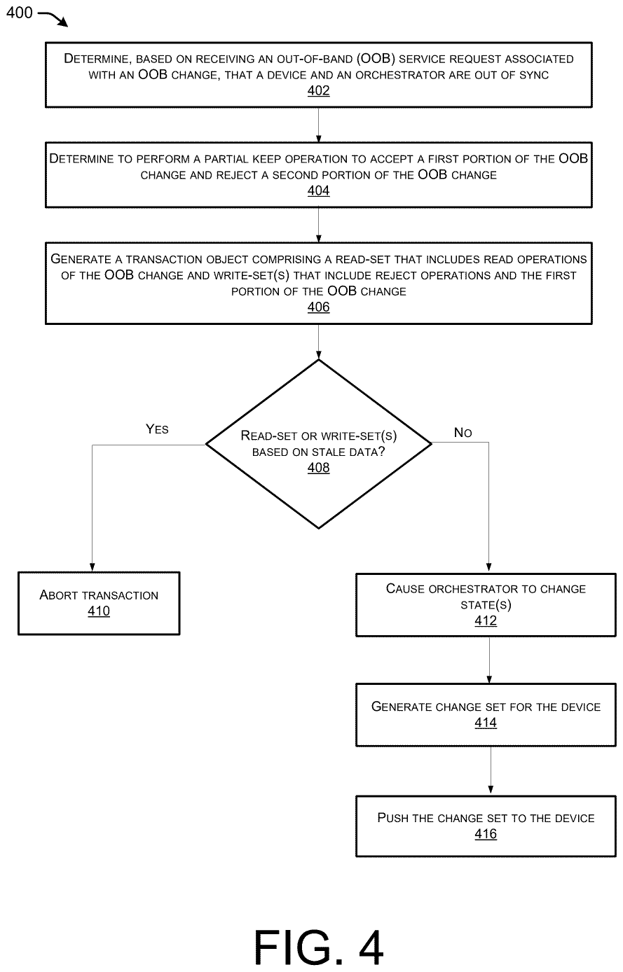

FIG. 4 illustrates a flow diagram of an example method 400 for performing ACID OOB transaction handling, according to the techniques described herein. In some instances, the steps of method 400 may be performed by a device (e.g., orchestrator 112, etc.) that includes one or more processors and one or more non-transitory computer-readable media storing computer-executable instructions that, when executed by the one or more processors, cause the one or more processors to perform operations of method 400.

At 402, the orchestrator may determine that a device and a controller are out of sync. In some examples, the orchestrator may determine the device and controller are out of sync in response to receiving an OOB service request associated with an OOB change made at the device. In some examples, the OOB change may cause the device to move from a first state to a second state. For instance, the first state may correspond to a first configuration state (e.g., such as State_0) and the second state may correspond to a second configuration state (e.g., such as State_1). In some examples, determining that the device and the orchestrator are out of sync is based at least in part on determining that a configuration included in a state of the device stored by the orchestrator is different from a configuration associated with the second state of the device indicated in the OOB service request.

At 404, the orchestrator may determine to perform a partial keep operation to accept a first portion of the OOB change and reject a second portion of the OOB change. For instance, the orchestrator may determine to perform the partial keep operation in response to receiving user input and/or automatically based on pre-defined user policies. As described herein, the first portion may comprise one or more configuration commands included in the OOB change and/or OOB service request.

At 406, the orchestrator may generate a transaction object comprising a read-set that includes read operations of the OOB change and write-set(s) that includes the write operations of the OOB change. For instance, the orchestrator may generate the transaction object (e.g., transaction 222), as described herein. In some examples, the write-set(s) may comprise a first write-set and a second write-set. The first write-set may comprise the first portion of the OOB change to be persisted in the orchestrator to cause the orchestrator to change states. The second write-set may comprise reject operations for the second portion of the OOB change to be pushed to the device to cause the device to change states. In some examples, the write-set(s) may comprise Delta_D 206.

In some examples, generating the transaction object further comprises: generating a second transaction object configured to generate the reject operations, the reject operations comprising a minimal difference between the first state and the third state; determining a second write-set comprising the reject operations; storing, the second write-set in the memory of the orchestrator; and loading the second write-set into the transaction object. The second write-set may comprise Delta_R 218. For instance, the second transaction object may correspond to trans-in-trans 224, as described herein. In some examples, the second transaction object is linked to the transaction object, and wherein generating the reject operations includes enabling the second transaction object to read from one or more of memory of the transaction object or the first state from the memory of the orchestrator.

At 408, the orchestrator may determine whether the read-set or the write-set(s) are based on stale data. For instance, the transaction may enter the critical section and determine whether any other transaction objects have been committed subsequent to the transaction object being generated. The transaction may determine that the read-set and/or write-set(s) are not based on stale data where no other transactions have been committed (e.g., none of the values used to generate the reject operations or the first portion of the OOB change have changed). The transaction may determine that the read-set or write-set(s) are based on stale data where another transaction has been committed (e.g., at least one of the values used to generate Delta_R and/or Delta_D have changed).

Where the orchestrator determines that the read-set or the write-set(s) are based on stale data (408-YES), the orchestrator may proceed to 410. At 410, the orchestrator may abort the transaction to prevent an incorrect configuration from being pushed to the device. For instance, based on determining that another transaction has been committed to storage after the transaction object is generated, the orchestrator may determine that at least one read operation or write operation is associated with stale data and/or a stale value. The orchestrator may then abort the transaction to prevent the at least one read operation or write operation from being pushed to the device.

Where the orchestrator determines that the read-set or the write-set(s) are not based on stale data (408-NO), the orchestrator may proceed to 412. At 412, the orchestrator may cause the orchestrator to change states. For instance, the orchestrator may save a first write-set of the write-set(s) of the transaction object in memory of the controller. The first write-set may comprise the first portion of OOB changes. The orchestrator may update the configuration of the device in persistent storage. For instance, the orchestrator may update a configuration of the device and the current state of the device in the data store 122 and/or other memory. In some examples, the data store 122 may comprise the first state of the device separately (e.g., such as where the first state is a preferred state of the device), such that the orchestrator may still access and/or utilize the first state. In some examples, saving the first write-set updates a state of the orchestrator to include the first portion of the OOB change and moves the orchestrator from the first state to the third state.

At 414, the orchestrator may generate a change set for the device. For instance, the change set may be generated using two transaction objects as described herein. In some examples, the change set may be based on a second write-set of the write-set(s). The second write-set may comprise the reject operations. The change set may comprise configuration commands representing a minimal difference to move the device from the second state and the third state. For instance, the change set may be based in part on a second write-set of the write-set(s) of the transaction object.

At 416, the orchestrator may push the change set to synchronize the device with the orchestrator. For instance, the orchestrator may utilize a southbound API, as described herein.

In some examples, the orchestrator may determine to perform a rollback operation on the orchestrator and the device to bring the orchestrator and the device out of sync; determine a first rollback configuration to cause the orchestrator to reset to the first state; determine a second rollback configuration comprising commands to cause the orchestrator to reset to the second state; store, in the memory of the orchestrator, the first rollback configuration; and push, to the device, the second rollback configuration. In some examples, determining to perform the rollback operation is based on determining a failure associated with pushing the change set to the device or receiving, from a user device, a request to rollback a successful commit.

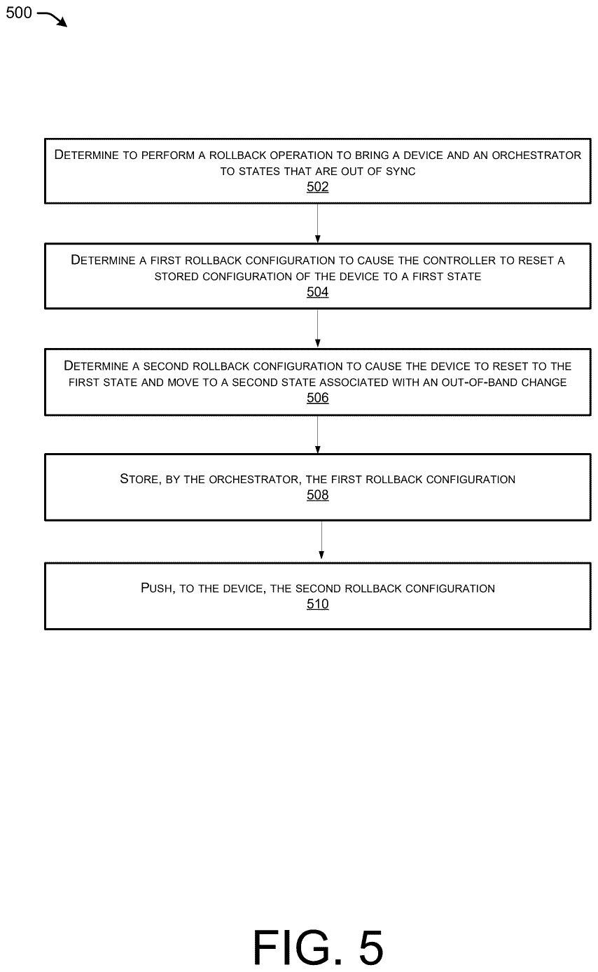

FIG. 5 illustrates a flow diagram of an example method 500 for performing a rollback operation, according to the techniques described herein. In some instances, the steps of method 500 may be performed by a device (e.g., orchestrator 112, etc.) that includes one or more processors and one or more non-transitory computer-readable media storing computer-executable instructions that, when executed by the one or more processors, cause the one or more processors to perform operations of method 500. In some examples, the operations of method 500 may be performed in addition to and/or independent of the operations of FIG. 4.

At step 502, the orchestrator may determine to perform a rollback operation to bring a device and the orchestrator to states that are out of sync. For instance, the orchestrator may determine to perform a rollback operation, where pushing a change set to the device (as described in FIG. 4) fails. In this example, in order for the transaction to be atomic, the orchestrator rolls the configurations of the device and the orchestrator back to the states they were in prior to the failure. In some examples, the orchestrator may determine to perform the rollback operation in response to receiving user input (e.g., such as user request to rollback a successful commit of the transaction performed in FIG. 4 and/or another transaction).

At step 504, the orchestrator may determine a first rollback configuration to cause the orchestrator to reset a stored configuration of the device to a first state. For instance, the first rollback configuration may be determined based on a preferred state of the device (e.g., such as State_0). The first rollback configuration may comprise configuration commands that reset the values of the stored configuration of the device to the values stored and/or associated with the first state. As described herein, the orchestrator may utilize the new transaction type to determine the first rollback configuration. As described herein, the new transaction type may utilize multiple write-sets.

At step 506, the orchestrator may determine a second rollback configuration to cause the device to reset to the first state and move to a second state associated with an out-of-band (OOB) change at the device. The first rollback configuration may comprise configuration commands that reset the values of the stored configuration of the device to the values stored and/or associated with the first state and/or second configuration commands that apply the OOB change to the first state. As described herein, the orchestrator may utilize the new transaction type to determine the second rollback configuration.

At step 508, the orchestrator may store the first rollback configuration. For instance, the orchestrator may store the first rollback configuration in memory. As an example, the first rollback configuration may be applied to a stored configuration associated with the device that represents a current state and/or configuration of the device. By applying the first rollback configuration to the stored configuration, the orchestrator may move the state of the device from the in-sync state (e.g., such as State_2) to the out-of-sync state (e.g., such as State_0).

At step 510, the orchestrator may push, to the device, the second rollback configuration. By pushing the second rollback configuration to the device, the orchestrator may cause the device to move from the in-sync state (e.g., such as State_2) to an out-of-sync state (e.g., such as State_1).

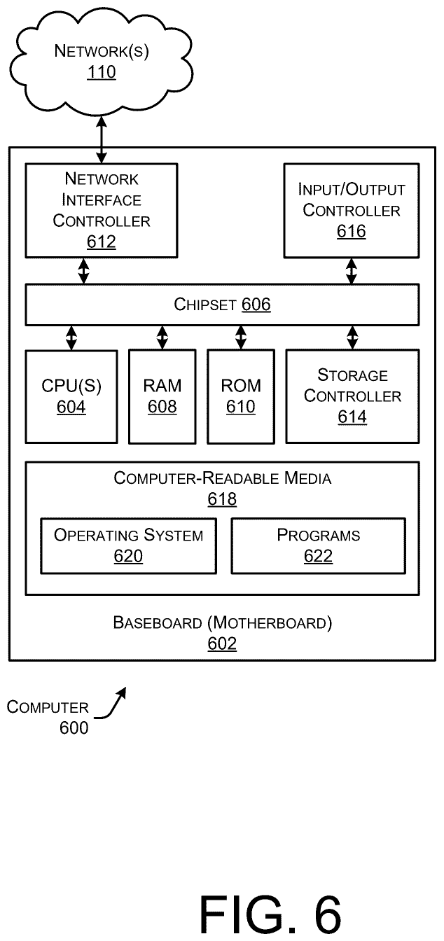

FIG. 6 shows an example computer architecture for a device capable of executing program components for implementing the functionality described above. The computer architecture shown in FIG. 6 illustrates any type of computer 600, such as a conventional server computer, workstation, desktop computer, laptop, tablet, network appliance, e-reader, smartphone, or other computing device, and can be utilized to execute any of the software components presented herein. The computer 600 may, in some examples, correspond to an orchestrator 112, and/or any other device described herein, and may comprise personal devices (e.g., smartphones, tables, wearable devices, laptop devices, etc.) networked devices such as servers, switches, routers, hubs, bridges, gateways, modems, repeaters, access points, and/or any other type of computing device that may be running any type of software and/or virtualization technology.

The computer 600 includes a baseboard 602, or “motherboard,” which is a printed circuit board to which a multitude of components or devices can be connected by way of a system bus or other electrical communication paths. In one illustrative configuration, one or more central processing units (“CPUs”) 604 operate in conjunction with a chipset 606. The CPUs 604 can be standard programmable processors that perform arithmetic and logical operations necessary for the operation of the computer 600.

The CPUs 604 perform operations by transitioning from one discrete, physical state to the next through the manipulation of switching elements that differentiate between and change these states. Switching elements generally include electronic circuits that maintain one of two binary states, such as flip-flops, and electronic circuits that provide an output state based on the logical combination of the states of one or more other switching elements, such as logic gates. These basic switching elements can be combined to create more complex logic circuits, including registers, adders-subtractors, arithmetic logic units, floating-point units, and the like.

The chipset 606 provides an interface between the CPUs 604 and the remainder of the components and devices on the baseboard 602. The chipset 606 can provide an interface to a RAM 608, used as the main memory in the computer 600. The chipset 606 can further provide an interface to a computer-readable storage medium such as a read-only memory (“ROM”) 610 or non-volatile RAM (“NVRAM”) for storing basic routines that help to startup the computer 600 and to transfer information between the various components and devices. The ROM 610 or NVRAM can also store other software components necessary for the operation of the computer 600 in accordance with the configurations described herein.

The computer 600 can operate in a networked environment using logical connections to remote computing devices and computer systems through a network, such as the network 102. The chipset 606 can include functionality for providing network connectivity through a NIC 612, such as a gigabit Ethernet adapter. The NIC 612 is capable of connecting the computer 600 to other computing devices over the network 110. It should be appreciated that multiple NICs 612 can be present in the computer 600, connecting the computer to other types of networks and remote computer systems.

The computer 600 can be connected to a storage device 618 that provides non-volatile storage for the computer. The storage device 618 can store an operating system 620, programs 622, and data, which have been described in greater detail herein. The storage device 618 can be connected to the computer 600 through a storage controller 614 connected to the chipset 606. The storage device 618 can consist of one or more physical storage units. The storage controller 614 can interface with the physical storage units through a serial attached SCSI (“SAS”) interface, a serial advanced technology attachment (“SATA”) interface, a fiber channel (“FC”) interface, or other type of interface for physically connecting and transferring data between computers and physical storage units.

The computer 600 can store data on the storage device 618 by transforming the physical state of the physical storage units to reflect the information being stored. The specific transformation of physical state can depend on various factors, in different embodiments of this description. Examples of such factors can include, but are not limited to, the technology used to implement the physical storage units, whether the storage device 618 is characterized as primary or secondary storage, and the like.

For example, the computer 600 can store information to the storage device 618 by issuing instructions through the storage controller 614 to alter the magnetic characteristics of a particular location within a magnetic disk drive unit, the reflective or refractive characteristics of a particular location in an optical storage unit, or the electrical characteristics of a particular capacitor, transistor, or other discrete component in a solid-state storage unit. Other transformations of physical media are possible without departing from the scope and spirit of the present description, with the foregoing examples provided only to facilitate this description. The computer 600 can further read information from the storage device 618 by detecting the physical states or characteristics of one or more particular locations within the physical storage units.

In addition to the mass storage device 618 described above, the computer 600 can have access to other computer-readable storage media to store and retrieve information, such as program modules, data structures, or other data. It should be appreciated by those skilled in the art that computer-readable storage media is any available media that provides for the non-transitory storage of data and that can be accessed by the computer 600. In some examples, the operations performed by the orchestrator 112, and or any components included therein, may be supported by one or more devices similar to computer 600. Stated otherwise, some or all of the operations performed by orchestrator 112, and or any components included therein, may be performed by one or more computer devices.

By way of example, and not limitation, computer-readable storage media can include volatile and non-volatile, removable and non-removable media implemented in any method or technology. Computer-readable storage media includes, but is not limited to, RAM, ROM, erasable programmable ROM (“EPROM”), electrically-erasable programmable ROM (“EEPROM”), flash memory or other solid-state memory technology, compact disc ROM (“CD-ROM”), digital versatile disk (“DVD”), high definition DVD (“HD-DVD”), BLU-RAY, or other optical storage, magnetic cassettes, magnetic tape, magnetic disk storage or other magnetic storage devices, or any other medium that can be used to store the desired information in a non-transitory fashion.

As mentioned briefly above, the storage device 618 can store an operating system 620 utilized to control the operation of the computer 600. According to one embodiment, the operating system comprises the LINUX operating system. According to another embodiment, the operating system comprises the WINDOWS® SERVER operating system from MICROSOFT Corporation of Redmond, Washington. According to further embodiments, the operating system can comprise the UNIX operating system or one of its variants. It should be appreciated that other operating systems can also be utilized. The storage device 618 can store other system or application programs and data utilized by the computer 600.

In one embodiment, the storage device 618 or other computer-readable storage media is encoded with computer-executable instructions which, when loaded into the computer 600, transform the computer from a general-purpose computing system into a special-purpose computer capable of implementing the embodiments described herein. These computer-executable instructions transform the computer 600 by specifying how the CPUs 604 transition between states, as described above. According to one embodiment, the computer 600 has access to computer-readable storage media storing computer-executable instructions which, when executed by the computer 600, perform the various processes described above with regard to FIGS. 1-5. The computer 600 can also include computer-readable storage media having instructions stored thereupon for performing any of the other computer-implemented operations described herein.

The computer 600 can also include one or more input/output controllers 616 for receiving and processing input from a number of input devices, such as a keyboard, a mouse, a touchpad, a touch screen, an electronic stylus, or other type of input device. Similarly, an input/output controller 616 can provide output to a display, such as a computer monitor, a flat-panel display, a digital projector, a printer, or other type of output device. It will be appreciated that the computer 600 might not include all of the components shown in FIGS. 1-5, can include other components that are not explicitly shown in FIG. 6, or might utilize an architecture completely different than that shown in FIG. 6.

As described herein, the computer 600 may comprise one or more of a orchestrator 112 and/or any other device. The computer 600 may include one or more hardware processors (processors and/or CPUs 604) configured to execute one or more stored instructions. The processor(s) may comprise one or more cores. Further, the computer 600 may include one or more network interfaces configured to provide communications between the computer 600 and other devices, such as the communications described herein as being performed by the orchestrator 112. The network interfaces may include devices configured to couple to personal area networks (PANs), wired and wireless local area networks (LANs), wired and wireless wide area networks (WANs), and so forth. For example, the network interfaces may include devices compatible with Ethernet, Wi-Fi™, and so forth.

The programs 622 may comprise any type of programs or processes to perform the techniques described in this disclosure for generating SNFs using a DSL and/or deploying SNFs to optimized network components.

While the invention is described with respect to the specific examples, it is to be understood that the scope of the invention is not limited to these specific examples. Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

Although the application describes embodiments having specific structural features and/or methodological acts, it is to be understood that the claims are not necessarily limited to the specific features or acts described. Rather, the specific features and acts are merely illustrative some embodiments that fall within the scope of the claims of the application.

What is claimed is:

1. A method for transactional handling of out-of-band (OOB) service requests by an orchestrator of a network, comprising:
determining, based on receiving an OOB service request associated with an OOB change, that a device and the orchestrator are out of sync, the OOB change causing the device to move from a first state to a second state;
determining to perform a partial keep operation to accept a first portion of the OOB change and reject a second portion of the OOB change;
generating a transaction object comprising a read-set that includes read operations of the OOB change and one or more write-sets that include the first portion of the OOB change and reject operations; and
based on determining the transaction object does not include operations based on stale data:
causing, based on the one or more write-sets, the orchestrator to move to a third state associated with the device;
generating, based on the one or more write-sets, a change set that comprises commands to (1) reset a configuration of the device to a stored configuration associated with the first state and (2) apply the second portion of the OOB change to move the device to the third state; and
pushing the change set to the device.

2. The method of claim 1, wherein generating the transaction object further comprises:
generating a second transaction object configured to generate the reject operations, the reject operations comprising a minimal difference between the first state and the third state;
determining a second write-set comprising the reject operations;
storing, the second write-set in memory of the orchestrator; and
loading the second write-set into the transaction object.

3. The method of claim 2, wherein the second transaction object is linked to the transaction object, and wherein generating the reject operations includes enabling the second transaction object to read from one or more of memory of the transaction object or the first state from the memory of the orchestrator.

4. The method of claim 1, further comprising:
determining to perform a rollback operation on the orchestrator and the device to bring the orchestrator and the device out of sync;
determining a first rollback configuration to cause the orchestrator to reset to the first state;
determining a second rollback configuration comprising commands to cause the device to reset to the second state;
storing, in memory of the orchestrator, the first rollback configuration to cause the orchestrator to move to the first state; and
pushing, to the device, the second rollback configuration.

5. The method of claim 4, wherein determining to perform the rollback operation is based on determining a failure associated with pushing the change set to the device or receiving, from a user device, a request to rollback a successful commit.

6. The method of claim 1, wherein based on determining that another transaction has been committed to storage after the transaction object is generated, the method further comprises:
determining that at least one read operation or write operation is associated with stale data; and
aborting the transaction to prevent the at least one read operation or write operation from being pushed to the device.

7. The method of claim 1, wherein causing the orchestrator to change states comprises saving a first write-set of the one or more write-sets to memory of the orchestrator, wherein the first write-set updates a state of the orchestrator to include the first portion of the OOB change and moves the orchestrator from the first state to the third state.

8. The method of claim 1, wherein determining that the device and the orchestrator are out of sync is based at least in part on determining that a state of the device stored by the orchestrator is different from the second state of the device indicated in the OOB service request.

9. A system comprising:
one or more processors; and
one or more non-transitory computer-readable media storing computer-executable instructions that, when executed by the one or more processors, cause the one or more processors to perform operations comprising:
determining, based on receiving an OOB service request associated with an out-of-band (OOB) change, that a device and an orchestrator of a network are out of sync, the OOB change causing the device to move from a first state to a second state;
determining to perform a partial keep operation to accept a first portion of the OOB change and reject a second portion of the OOB change;
generating a transaction object comprising a read-set that includes read operations of the OOB change and a write-set that include the first portion of the OOB change and reject operations; and
based on determining the transaction object does not include operations based on stale data:
causing, based on the one or more write-sets, the orchestrator to move to a third state associated with the device;
generating, based on the one or more write-sets, a change set that comprises commands to (1) reset a configuration of the device to a stored configuration associated with the first state and (2) apply the second portion of the OOB change to move the device to the third state; and
pushing the change set to the device.

10. The system of claim 9, wherein generating the transaction object further comprises:
generating a second transaction object configured to generate the reject operations, the reject operations comprising a minimal difference between the first state and the third state;
determining a second write-set comprising the reject operations;
storing, the second write-set in memory of the orchestrator; and
loading the second write-set into the transaction object.

11. The system of claim 10, wherein the second transaction object is linked to the transaction object, and wherein generating the reject operations includes enabling the second transaction object to read from one or more of memory of the transaction object or the first state from the memory of the orchestrator.

12. The system of claim 9, the operations further comprising:
determining to perform a rollback operation on the orchestrator and the device to bring the orchestrator and the device out of sync;
determining a first rollback configuration to cause the orchestrator to reset to the first state;
determining a second rollback configuration comprising commands to cause the device to reset to the second state;
storing, in memory of the orchestrator, the first rollback configuration; and
pushing, to the device, the second rollback configuration.

13. The system of claim 12, wherein determining to perform the rollback operation is based on determining a failure associated with pushing the change set to the device or receiving, from a user device, a request to rollback a successful commit.

14. The system of claim 9, wherein based on determining that another transaction has been committed to storage after the transaction object is generated, the operations further comprising:
determining that at least one read operation or write operation is associated with stale data; and
aborting the transaction to prevent the at least one read operation or write operation from being pushed to the device.

15. The system of claim 9, wherein causing the orchestrator to change states comprises saving a first write-set of the one or more write-sets to memory of the orchestrator, wherein the first write-set updates a state of the orchestrator to include the first portion of the OOB change and moves the orchestrator from the first state to the third state.

16. The system of claim 9, wherein determining that the device and the orchestrator are out of sync is based at least in part on determining that a state of the device stored by the orchestrator is different from the second state of the device indicated in the OOB service request.

17. One or more non-transitory computer-readable media storing computer-readable instructions that, when executed by one or more processors, cause the one or more processors to perform operations comprising:
determining, based on receiving an out-of-band (OOB) service request associated with an OOB change, that a device and an orchestrator of a network are out of sync, the OOB change causing the device to move from a first state to a second state;
determining to perform a partial keep operation to accept a first portion of the OOB change and reject a second portion of the OOB change;
generating a transaction object comprising a read-set that includes read operations of the OOB change and one or more write-sets that include the first portion of the OOB change and reject operations; and
based on determining the transaction object does not include operations based on stale data:
causing, based on the one or more write-sets, the orchestrator to move to a third state associated with the device;
generating, based on the one or more write-sets, a change set that comprises commands to (1) reset a configuration of the device to a stored configuration associated with the first state and (2) apply the second portion of the OOB change to move the device to the third state; and
pushing the change set to the device.

18. The one or more non-transitory computer-readable media of claim 17, the operations further comprising:
determining to perform a rollback operation on the orchestrator and the device to bring the orchestrator and the device out of sync;
determining a first rollback configuration to cause the orchestrator to reset to the first state;
determining a second rollback configuration comprising commands to cause the device to reset to the second state;
storing, in memory of the orchestrator, the first rollback configuration; and
pushing, to the device, the second rollback configuration.

19. The one or more non-transitory computer-readable media of claim 17, wherein generating the transaction object further comprises:
generating a second transaction object configured to generate the reject operations, the reject operations comprising a minimal difference between the first state and the third state;
determining a second write-set comprising the reject operations;
storing, the second write-set in memory of the orchestrator; and
loading the second write-set into the transaction object.

20. The one or more non-transitory computer-readable media of claim 19, wherein the one or more write-sets include:
a first write-set comprising the first portion of the OOB changes; and
a second write-set comprising the reject operations.
